(19) United States
(12) Patent Application Publication
(10) Pub. No.: US 2002/0196430 A1
(43) Pub. Date: Dec. 26, 2002

(54) Measuring optical signal power in an optical system

(76) Inventors: Gregory D. May, Ottawa (CA); Robert W. Keys, Stittsville (CA); David W. Park, Kanata (CA); Douglas Eccleston, Big Flats, NY (US)

Correspondence Address: WITHROW & TERRANOVA, P.L.L.C., P.O. BOX 1287, CARY, NC, 27512, US

(21) Appl. No.: 10/027,249

(22) Filed: Dec. 20, 2001

Related U.S. Application Data
(60) Provisional application No. 60/257,392, filed on Dec. 22, 2000.

(51) Int. Cl. G01J 1/00

(52) U.S. Cl. 356/213

(57) ABSTRACT

An optical system includes an optical medium which carries wavelengths of light, an optical tap which siphons the wavelengths from the optical medium, and a wavelength select switch having output ports. The wavelength select switch receives the wavelengths from the tap and selectively passes at least one of the wavelengths to one of the output ports. A power meter receives the at least one wavelength from the output port and measures power in the at least one wavelength.

This application claims the benefit of Provisional Patent application Serial No. 60/257,392, filed Dec. 22, 2000, which is incorporated herein by reference.

### BACKGROUND

This invention relates to measuring optical signal power in an optical system, such as a dense wavelength division multiplexing (DWDM) system.

Optical systems, such as DWDMs, transmit data over an optical media, such as a fiber optic cable. Data is typically transmitted over a range of wavelengths, also referred to as optical signals or channels, and multiplexed onto a single optical medium. To ensure acceptable data transmission, the power of each optical signal is maintained above a predetermined level. Systems have been devised for measuring optical signal power, but have been found to be unsatisfactory for one reason or another.

### DESCRIPTION OF THE DRAWINGS

FIG. 1 is block diagram of an optical system.

FIG. 2 is a flowchart of a process for measuring the power of signals in the optical system.

FIG. 3 is a block diagram of an exemplary implementation of a controller in the system of FIG. 1 provided as a programmable computer.

### DESCRIPTION

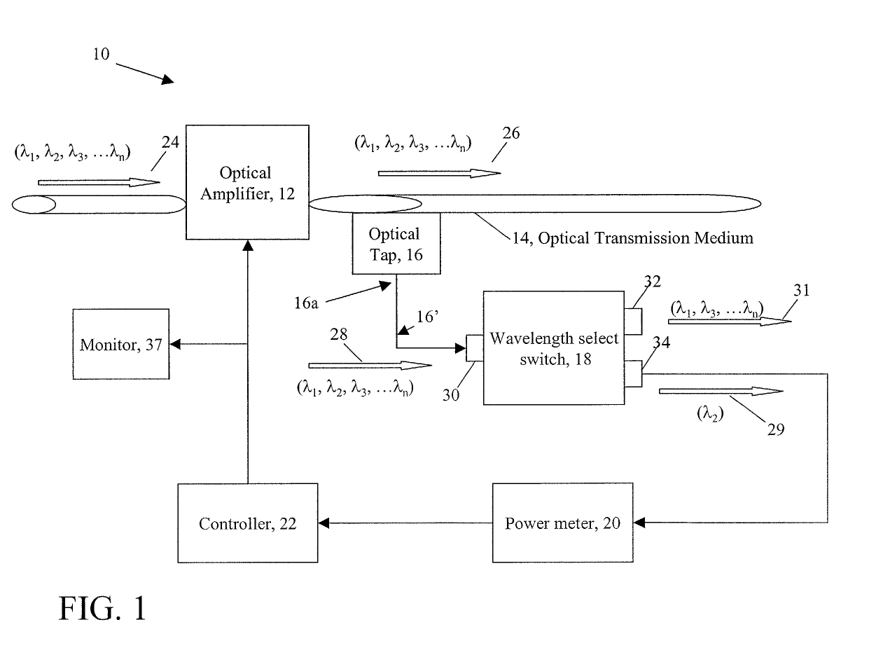

Referring to FIG. 1, an optical system, such as a dense wavelength division multiplexing (DWDM) system 10 is shown. The DWDM system 10 includes an optical amplifier 12 coupled to an optical transmission medium 14. The system also includes an optical tap 16 coupled to the optical medium 14. An output 16a of the optical tap 16 is coupled to a wavelength select switch 18, e.g., via another optical medium 16′. The DWDM system 10 also includes a power meter 20 coupled to the wavelength select switch 18 and controller 22 that receives an output signal from the power meter 20 to generate a control signal to control the optical amplifier 12, as shown or to provide an indication of a power measurement.

The optical amplifier 12 receives multiplexed signals 24 having different wavelengths (optical channels) λ₁, λ₂, λ₃, λ₄ . . . λₙ. The optical amplifier 12 amplifies or boosts the gain of those signals for transmission over the optical medium 14. Optical medium 14 is a fiber optic cable or the like. The optical medium 14 transmits optical traffic, including the multiplexed signals.

Various types of optical taps can be used. In one embodiment, the optical tap 16 is an optical splitter. The optical tap 16 diverts a portion of the power from each of the amplified signals 26 (λ₁, λ₂, λ₃, λ₄ . . . λₙ) passing through optical transmission medium 14 to its output 16a. The diverted signal portions 28 are fed to the wavelength select switch 18. Optical tap 16 as a power splitter, or the like, typically diverts about 5% of the original input power of the signals 26 incident on the optical transmission medium 14. The amount of power that is diverted may vary, however, due to system requirements and configuration. Any portion of the power may be diverted.

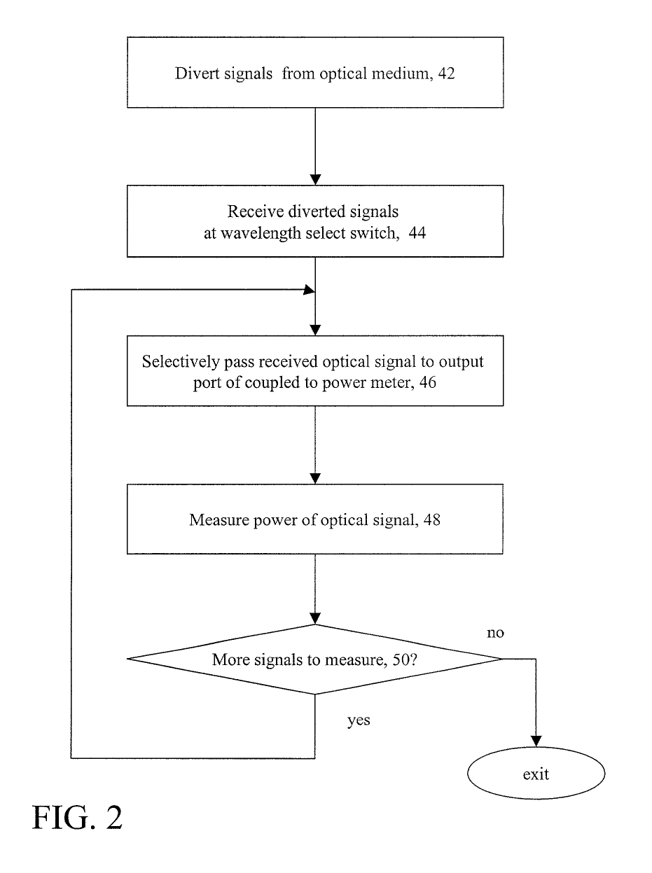

Wavelength select switch 18 includes an input port 30 and at least two output ports 32 and 34. A two-input wavelength select switch, known as a crossbar switch, may be used, however, only one of its inputs would receive signals 28. In operation, wavelength select switch 18 receives the diverted signals 28 (λ₁, λ₂, λ₃, λ₄ . . . λₙ) from optical tap 16 at input port 30 and selectively directs those signals to its output ports 32 and 34, as described below in FIG. 2.

As shown in FIG. 1, the output port 34 of the wavelength select switch 18 connects to power meter 20. The wavelengths directed to output port 34 are fed to the power meter 20, which measures the power, i.e., the signal strength of the signals. A single signal (wavelength) directed to output port 34, and thus to power meter 20, would provide at the output of the power meter 20, a measure of the power or signal strength of that signal. Also, multiple signals (wavelengths) may be directed to the power meter from the wavelength select switch 18 at approximately the same time. In the case where multiple signals are directed to output port 34 of power meter 20, the measured power level of the signals is the combined power of all of the signals.

Controller 22, which may be part of a computer or other processing device, receives the power measurement from power meter 20. Controller 22 may display on a monitor 37 that power measurement to a system administrator or use it to control optical amplifier 12, as described below.

Referring to FIG. 2, a process 40 is shown for measuring the power of signals 26 passing through the optical system 10. The measuring process 40, has the optical tap 16 diverting 42 power from incident signals 26 that pass though optical medium 14 to provide signals 28 (λ₁, λ₂, λ₃, λ₄ . . . λₙ). These signals 28 are of the same wavelengths (optical channels) as their counterpart signals 26 on optical medium 14, but generally at a lower power level. In this embodiment, signals 28 constitute only about 5% of the total power of signals 26, although, as mentioned above, the arrangement is not limited to diverting only 5% of the total power of signals 26.

Wavelength select switch 18 receives 44 the diverted signals 28 and passes (46) one (or more) of those signals 28 (i.e., signal 29—λ₂) to output port 34 connected to power meter 20. Power meter 20 measures 48 the power of signal 29 and provides that measurement to controller 22. The remaining optical signals 31 (λ₁, λ₃, λ₄ . . . λₙ) are passed to output port 32, which may be unconnected or connected to other circuitry (not shown) for processing the remaining optical signals 31.

Controller 22 may use the power measurement in a variety of ways. For example, controller 22 may display, on a monitor (not shown), an indication of the power of signal 29 to a system administrator. Controller 22 may determine if the power in that optical signal 29 has crossed a predetermined threshold or has fallen outside of an acceptable range of power levels and trigger an alarm if that has occurred. In the event of a threshold crossing, controller 22 may control optical amplifier 12 to regulate the power of one or more of signals 26 on optical medium 14. For example, if the power is too low (below the threshold), controller 22 can send a control signal to optical amplifier 12 to cause the optical amplifier to boost the gain of the signal and hence increase the signal strength of λ₂. Conversely, if the power level is too high (above a second threshold), controller 22 may send a signal to optical amplifier to decrease the signal strength of λ₂. The threshold values of the signals may be set beforehand in controller 22 and can be adjusted to account for comparing only 5% of the total signal strength from optical medium 14. The power measurement from power meter 20 may also be used to equalize channel optical signal-to-noise ratios of all channels on optical system 10. Controller 22 may be programmed to do this automatically or the necessary information may be provided to a system administrator.

Once the power of signal 29 has been measured, process 40 cycles through other signals 31 to measure the power of those other signals 50. That is, wavelength select switch 18 selects a new one of signals 28 (λ₁, λ₂, λ₃, λ₄ . . . λₙ) and the power is measured for that new signal. Process 40 continues cycling through the various signals 28, either one at time or in groups, as those signals are obtained from optical medium 14. Wavelength select switch 18 may select signals 28 in any sequence.

Although the foregoing focuses on measuring the power of a single signal 29, as noted, wavelength select switch 18 may direct a subset of signals 28 (i.e., more than one) to output port 34. In this case, power meter 20 measures the combined strength of those signals. Which signals are directed to output port 34 is determined by wavelength select switch 18. This information may be set beforehand in wavelength select switch 18 or it may be downloaded thereto, e.g., from a user interface (not shown) via controller 22.

The controller 22 can be implemented in digital electronic circuitry, or in computer hardware, firmware, software, or in combinations thereof. Aspects of the controller 22 can be implemented in a computer program product tangibly embodied in a machine-readable storage device for execution by a programmable processor. Method actions can be performed by a programmable processor executing a program of instructions to perform functions of the controller 22 by operating on input data and generating output. Computer programs can be implemented in a high-level procedural or object oriented programming language, or in assembly or machine language if desired; and in any case, the language can be a compiled or interpreted language. Suitable processors include, by way of example, both general and special purpose microprocessors, or controllers.

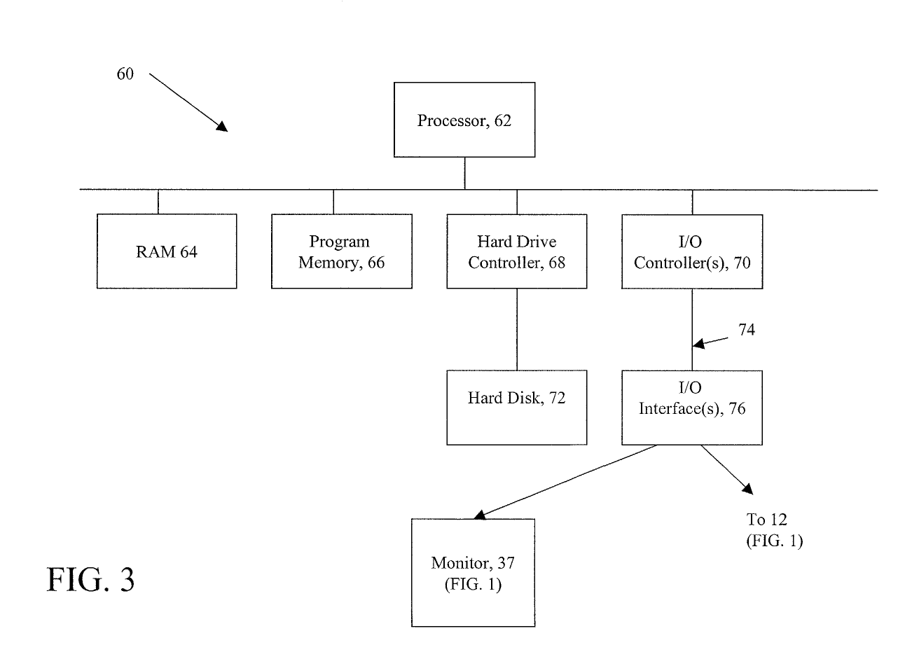

An example of one such type of computer is shown in FIG. 3, which shows a block diagram of a programmable processing system (system) 60 suitable for implementing controller. The system 60 includes a processor 62, a random access memory (RAM) 64, optionally a separate program memory 66 (for example, a writable read-only memory (ROM) such as a flash ROM), a hard drive controller 68, and an input/output (I/O) controller 70 coupled by a processor (CPU) bus 70.

The hard drive controller 68 is coupled to a hard disk 72 suitable for storing executable computer programs. The I/O controller(s) 70 is coupled by I/O bus(s) 74 to I/O interface(s) 76. The I/O interface(s) 76 receives and transmits data in analog or digital form e.g., signals from the power meter 20 and to the optical amplifier 14 or a monitor 37.

The invention is not limited to the specific embodiments set forth herein. For example, wavelength select switch 18 may have multiple power meters connected to multiple output ports to measure signal strength of multiple signals. Also, the wavelength select switch 18 may include more than two output ports and may be configured to selectively apply wavelengths to its various output ports, as needed, to measure the power of separate signals simultaneously. Also, although the invention has been described in the context of a DWDM system, it may be applied to any optical system for measuring signal power.

Other embodiments not described herein are also within the scope of the following claims.

What is claimed is:

1. A method of measuring optical signal power in an optical system, comprising:
receiving optical signals at a wavelength select switch;
coupling a received optical signal through the wavelength select switch to a power meter; and
measuring a power level of the optical signal passed through the wavelength select switch using the power meter.

2. The method of claim 1, further comprising:
passing a subset of the optical signals through the wavelength select switch at substantially the same time; and
measuring power in the subset of optical signals using the power meter.

3. The method of claim 1 wherein the optical signals comprise different wavelengths of optical energy.

4. The method of claim 1, further comprising:
diverting a portion of optical energy on an optical medium to obtain the optical signals.

5. The method of claim 4 wherein diverting comprises:
using a power splitter to divert a portion of the signal power from an incident signal.

6. The method of claim 1 wherein the optical system comprises a dense wavelength division multiplexing (DWDM) system.

7. The method of claim 1, further comprising:
successively directing other ones of the optical signals through the wavelength select switch to the power meter; and
measuring power in the other optical signals using the power meter.

8. The method of claim 1 wherein the wavelength select switch is a crossbar switch having one or more inputs for receiving the optical signals.

9. The method of claim 1, further comprising:
displaying an indication of the power in the optical signal.

10. The method of claim 1, further comprising:
determining if the power in the optical signal has crossed a predetermined threshold; and
triggering an alarm if the power in the optical signal has crossed the predetermined threshold.

11. The method of claim 1, wherein the optical system includes a transmission medium from which the optical signals are received, and the method further comprises:
controlling an optical amplifier in accordance with the power of the optical signal to regulate optical power of the optical signals on the transmission medium.

12. Apparatus for measuring optical signal power in an optical system, comprising:
a wavelength select switch having output ports to selectively pass a received optical signal to one of the output ports; and
a power meter which receives the optical signal from the output port and measures the power in the optical signal.

13. The apparatus of claim 12 wherein the wavelength select switch passes a subset of the optical signals to the output port at the same time and the power meter measures power in the subset of optical signals.

14. The apparatus of claim 12 wherein the optical signals comprise different wavelengths of light.

15. The apparatus of claim 12, further comprising:
an optical tap that diverts a portion of optical signals incident on an optical medium to obtain the optical signals.

16. The apparatus of claim 15 wherein the optical tap diverts a portion of power from the optical traffic.

17. The apparatus of claim 12 wherein the optical system comprises a dense wavelength division multiplexing (DWDM) system.

18. The apparatus of claim 12 wherein the wavelength select switch cycles others of the optical signals to the output port and the power meter measures power in the other optical signals.

19. The apparatus of claim 12 wherein the wavelength select switch is a crossbar switch having one or more inputs for receiving the optical signals.

20. An optical system comprising:
an optical medium which carries different wavelength of optical energy;
an optical tap which siphons the different wavelengths of optical energy from the optical medium;
a wavelength select switch having output ports, which receives the siphoned wavelengths of optical energy from the tap and which selectively passes at least one of the wavelengths to one of the output ports; and
a power meter which receives the at least one wavelength from the output port and which measures power in the at least one wavelength.

21. The optical system of claim 20 wherein the optical tap siphons only a portion of the wavelengths from the optical medium.

22. The optical system of claim 20 wherein the wavelength select switch passes, to another of the optical ports, a wavelength that is not included in the at least one wavelength.

23. The optical system of claim 20, further comprising:
an optical amplifier which regulates power of the wavelengths of light on the optical medium in response to measured power in the at least one wavelength.
